(19) United States
(12) Patent Application Publication
(10) Pub. No.: US 2006/0099859 A1
(43) Pub. Date: May 11, 2006

(54) Measuring and sorting apparatus

(76) Inventor: Matthias Kaspar, Bielefeld (DE)

Correspondence Address: SEYFARTH SHAW LLP, 55 E. MONROE STREET, SUITE 4200, CHICAGO, IL, 60603-5803, US

(21) Appl. No.: 11/270,134

(22) Filed: Nov. 9, 2005

(30) Foreign Application Priority Data
Nov. 10, 2004 (DE) 20 2004 017 425.1

(51) Int. Cl. H01R 24/00

(52) U.S. Cl. 439/676

(57) ABSTRACT

Measuring and sorting apparatus for connecting elements comprising a receiving nest to which the connecting elements are supplied and in which only one connecting element is positionable in an oriented manner; a sensing device sensing one or several dimensions of the connecting element positioned in said receiving nest to distinguish between defective and correct connecting elements; an ejecting device ejecting defective connecting elements from the receiving nest; and a transferring device transferring correct connecting elements to a further processing unit.

### 1. FIELD OF THE INVENTION

The present invention relates to a measuring and sorting apparatus for connecting elements, in particular a length measuring and sorting apparatus in a feeding and separating process for punch rivets supplied to a punch riveting machine.

### 2. BACKGROUND OF THE INVENTION

In different industrial fields of production, connecting elements are used as for example punch rivets, rivets, blind rivets, pins and bolts. They are loosely processed in mass production, and they are supplied to a processing system adapted to these connecting elements. The manufacture of car bodies is one example in which sheet metals are connected to each other by means of above rivets.

Before or during the above feeding process of connecting elements, they are individualized or separated from each other in a separating process. After separation, the connecting elements can be individually fed to the connecting apparatus, as for example the riveting machine. For the individual supply, e.g. a supply tube, a guiding or a magazine is used.

In order to connect the above mentioned metal sheets by means of punch rivets, the length of the punch rivet has to be adapted to the thickness of the metal sheets. If the length of the punch rivet is not properly set, the above metal sheets are not reliably connected. It is therefore necessary to determine the length of the connecting elements and to sort out the inappropriate connecting elements before they are supplied to the riveting machine.

Up to now, the connecting elements have been sorted out for example by means of a reference gauge. This reference gauge is comparable to a template which can be passed through by connecting elements having the right length while too long connecting elements are blocked by the template or the reference gauge, respectively. As soon as the connecting element is blocked by the reference gauge, it is manually sorted out in order to continue the checking and sorting process thereafter.

According to a further alternative, the length of the punch rivet is determined by the punch riveting machine shortly before processing the same. If the punch riveting machine recognizes an inappropriate or defective rivet, the riveting process is interrupted for removing the same. This leads to a stop in the operating cycle and to machine down-time.

It is therefore the problem of the present invention, to provide a measuring and sorting apparatus for connecting elements which realizes dimension checking to reduce machine down-time and to improve the operating cycle.

### 3. SUMMARY OF THE INVENTION

A measuring and sorting apparatus for connecting elements according to the present invention is defined in the independent claim. Advantageous developments of the present invention are defined in the dependent claims.

The inventive measuring and sorting apparatus for connecting elements comprises a receiving nest to which the connecting elements are supplyable and in which one connecting element is positionable in an oriented way, respectively; a sensing device sensing one or several dimensions of the connecting element positioned in the receiving nest to distinguish between defective and correct connecting elements dependent on the measured one or several dimensions; an ejecting component ejecting defective connecting elements from the receiving nest; and a transferring component moving correct connecting elements to a further processing unit.

The present invention provides a compact arrangement in which at least one dimension of connecting elements, particularly the length of punch rivets, is precisely and individually measured. Based on the precise determination of the connecting element's dimension, the apparatus recognizes the suitability of the connecting element with respect to later connecting processes. Starting from this result, only single suitable connecting elements are passed on so that a later separating and connecting process has not to be interrupted due to defective connecting elements. The defective connecting elements are sorted out by the inventive apparatus since they do not provide the appropriate dimension for a later connecting process. In this manner, the later separating and processing of the connecting elements is prepared based on the individual measuring and sorting by means of the inventive apparatus.

According to a preferred embodiment of the present invention, the measuring and sorting apparatus comprises a sensing element movable through the receiving nest to an ejecting position so that the sensing element is used on the one hand for determining the dimension of the connecting element and on the other hand as an ejector of the ejecting component.

By means of the sensing element, the present invention preferably senses mechanically the dimension, in particular the length, of the connecting element to be tested. Besides determining the length, the sensing element is also preferably used as an ejector for defective connecting elements. Since the ejecting is carried out along the same axis as the sensing, and the length measurement of the connecting element, respectively, the ejecting can be done without new positioning of the defective connecting element. This fact accelerates the measuring and sorting process of the apparatus. Additionally, the constructional efforts of the apparatus are reduced by the combination of these two functions in only one constructive element.

According to a further preferred embodiment of the present invention, the transferring component comprises a displacer in which the receiving nest is formed. By means of the displacer, the receiving nest is preferably moveable between the feeding position adjacent a feeding component for the connecting elements and a removing position adjacent a removing component leading to a further processing of the connecting elements to separate the connecting elements. To this end, the connecting elements are preferably supplied sequentially or in a row to the receiving nest by means of the feeding component wherein the connecting elements are arranged adjacent to each other and in the right position within the feeding component. Preferably, the feeding position of the receiving nest is also a working position in which connecting elements arranged in the receiving nest are sensed and in which defective connecting elements are ejected.

According to a further preferred embodiment of the present invention, the distribution of the correct and defective connecting elements is achieved by means of the transferring component. The transferring component provides a displacer in which the receiving nest is formed. The displacer moves the receiving nest preferably along an axis. At the working position, this axis crosses the axis along which the sensing element moves for sensing and ejecting. In the intersection of the two axes, the connecting elements are preferably supplied to the receiving nest, sensed in this position and ejected in this position if a defective connecting element was determined. Further, the displacer individually moves the correct connecting elements to a removing position from which they are transferred to a further processing unit for separating and later processing. By means of the preferred combination of the displacer and the sensing and ejecting device, long ways of transfer of the defective and correct connecting elements are avoided. This construction saves time while sorting the connecting elements and it realizes the sorting by means of limited constructive efforts whereby the later separating process is prepared additionally.

According to a further embodiment, the displacer forms the transferring component and the ejecting device for sorting defective and correct connecting elements. For this purpose, the displacer is configured in such a way that it can be moved to an ejecting position for ejecting defective connecting elements differing from the feeding position and the removing position.

According to the above described other embodiment, the displacer realizes the ejecting as well as the transferring of the connecting elements so that the displacer sorts out the connecting elements alone. This technical solution additionally provides a space saving construction since the measuring and sorting apparatus can be realized without the movable stop as well as the actuating cylinder for moving the stop. For reaching the different displacer's positions, the displacer is preferably moved by means of a multi-position cylinder.

According to a preferred embodiment of the present invention, the connecting elements are punch rivets and the further processing unit is a punch riveting machine. Furthermore, the dimension to be measured is preferably the length of the connecting element.

### 4. SHORT DESCRIPTION OF THE ACCOMPANYING DRAWING

Preferred embodiments of the present invention are described with reference to the accompanying drawing. It shows:

FIG. 1 a horizontal schematic sectional view of a preferred embodiment of the present invention,

FIG. 2 an enlarged view of the encircled area of FIG. 1, and

FIG. 3 a schematic horizontal sectional view of a further preferred embodiment of the present invention.

### 5. DETAILED DESCRIPTION OF THE PREFERRED EMBODIMENTS

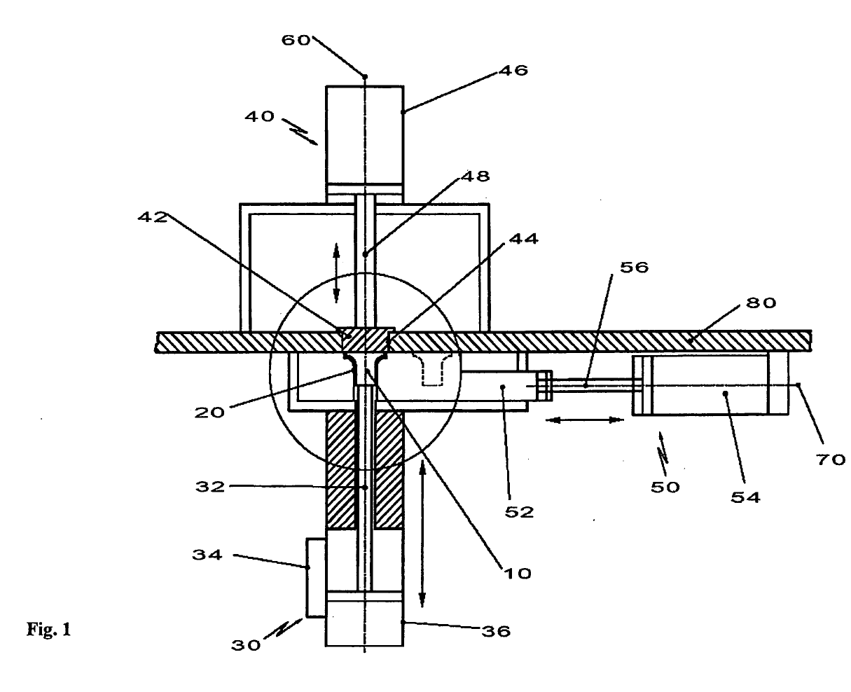

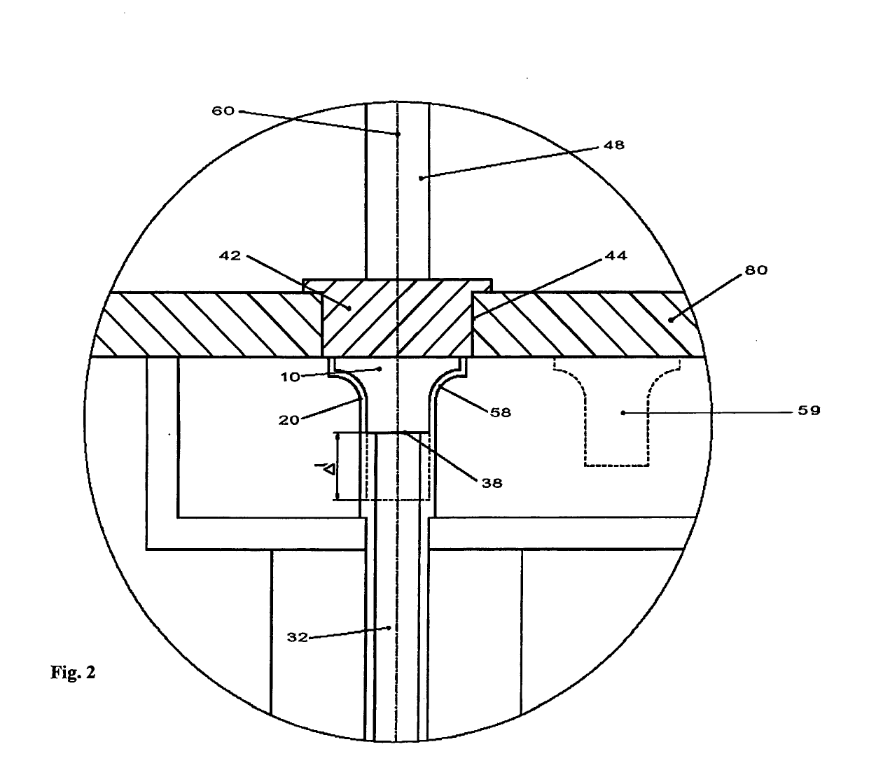

According to a preferred embodiment, the measuring and sorting apparatus serves for a length measurement of punch rivets in their feeding and separating processing. To this end, the rivets are individually fed or supplied to the measuring and sorting apparatus, the rivet length is determined, the result of the length measurement is evaluated, and subsequently, the measured rivet is sorted out dependent on the result of the evaluation. For executing the condensed presented steps, the measuring and sorting apparatus requires constructive elements which are described in the following with reference to FIGS. 1 and 2.

FIG. 1 shows a horizontal sectional view of the measuring and sorting apparatus according to a preferred embodiment of the present invention. A vertically arranged base plate 80 is arranged approximately in the middle of the shown measuring and sorting apparatus. Different elements of the measuring and sorting apparatus are arranged at opposite sides of the base plate 80 wherein these elements are situated in a common horizontal plane.

A receiving nest 20 is arranged directly adjacent to one side of the base plate 80. This receiving nest 20 is formed in a displacer 52 which is described in more detail below. The shape of the receiving nest 20 is preferably adapted to the shape of the connecting element 10 to be received. To this end, the receiving nest 20 is complementary shaped to the connecting element 10 to be received, respectively. According to a preferred embodiment of the present invention shown in FIG. 2, the receiving nest 20 is configured for receiving a punch rivet 10. It thus comprises an expanded portion directed to the base plate 80 in which the head of the rivet 10 is received. It further comprises a tapered portion at the end opposed to the base plate 80 in which the rivet body is retained. By adapting the receiving nest 20 to the shape of the connecting element to be received, a correct positioning of the connecting element is already realized by feeding the connecting element 10 into the receiving nest 20. It is therefore preferred to adapt the receiving nest 20 to the shape of for example punch rivets, blind rivets, pins, and bolts. If other small parts should be evaluated and sorted out by means of the measuring and sorting apparatus, the receiving nest 20 is appropriately configured to receive and, to position at the same time, and to retain the elements to be measured in order to facilitate a later measuring and sorting process in this manner.

The receiving nest 20 is preferably open at the end adjacent to the base plate 80 as well as at its opposite end. The base plate 80, correctly speaking a movable stop 42 of the base plate 80, closes one end of the receiving nest 20. The end of the receiving nest 20 opposite to the base plate 80 is open so that the connecting element 10 is accessible by a sensing device 30 within the receiving nest 20 for determining its dimension, in particular its length.

The sensing device 30 serves for determining the dimension of the connecting element, i.e. for example its length, width, height or diameter, here preferably the length of the connecting element. For determining this length, a sensing element 32 is preferably linearly moved between an initial position and a sensing position along an axis 60. The movement of the sensing element 32 is carried out by a linear actuator 35 which is preferably a pneumatic or hydraulic piston-cylinder-actuator, an electromagnetic actuator, an electromechanical actuator, as for example a spindle and an electric motor, or other conceivable actuators which are able to move the required distance of the sensing device 30.

The sensing device 30 moves the sensing element 32 between the initial position outside the receiving nest 20 where no length measurement of the connecting element 10 is executed, and the sensing position within the receiving nest 20 where the sensing takes place. If thus the sensing element 32 is situated in the initial position, the receiving nest 20 is free for feeding and removing connecting elements 10. If the sensing element 32 is in the sensing position, it pushes against the end of the connecting element 10 opposite to the base plate 80 until the other end of the connecting element 10 abuts the base plate 80. As soon as the sensing element 32 does not move any more during this pushing process, the sensing position is reached. In this position, the sensing device 30 determines the distance between the initial position and the sensing position covered by the sensing element 32 by means of a distance sensor 34. Based on determining the distance by the preferred digital or analogous distance sensor 34, the length of the connecting element 10 is determined since the distance between the initial position and the base plate 80 is known. Additionally, the length measurement of the connecting element 10 is executed with high accuracy of e.g. ±0.1 mm, due to the use of the digital or analogous distance sensor 34. The distance sensor 34 is preferably based on optical, inductive or other electronic systems for determining the length of the connecting element 10. To this end, the displacement of the sensing element 32 is preferably detected which can be realized at an arbitrary position of the sensing element 32. For example, the displacement of the sensing element 32 is qualified by Δ1 in FIG. 2 wherein this displacement was determined at the upper end of the sensing element 32. In the same manner, the displacement can be sensed at the lower end of the sensing element 32 by means of a sensor or in another appropriate manner.

In the sensing device 30 or in a connected evaluation unit (not shown), preferably a personal computer, the determined distance is evaluated. If the length of the connecting element 10, which was evaluated from the determined distance, forms part of a length interval so that the connecting element 10 can be further processed, the result of the evaluation is qualified by “OK”. In case the evaluated length of the connecting element 10 lies not within the above interval, the measured connecting element 10 is marked or qualified by “not OK”. Based on the evaluation result, the further operation of the measuring and sorting apparatus is carried out, in particular the sorting of the measured connecting elements 10.

Besides the length, one or several dimensions of the connecting element 10 could be sensed while said connecting element 10 is arranged within the receiving nest 20. To this end, e.g. a further sensing element (not shown) could be installed perpendicularly to axis 60 in order to measure for example the diameter of the connecting element 10 through a further opening (not shown) in said receiving nest 20. Corresponding to the requirements of the connecting element 10, several dimensions can therefore be sensed and evaluated in the above evaluation unit in order to consider the evaluation result during the following sorting process.

If the result of the evaluation is “OK” the measured connecting element 10 is transferred to a further processing unit by means of a transferring device 50. This transferring device 50 is preferably realized by means of the above mentioned displacer 52. In case the above evaluation result is “not OK”, i.e. it qualifies a defective connecting element 10 being too long or too short, this connecting element 10 is removed from the receiving nest 20 (see below) by the preferred ejecting device 30, 40.

If the measured connecting element 10 is “OK”, a sorting process is carried out by means of the displacer 52 in which the receiving nest 20 is formed. According to a preferred embodiment, the displacer 52 moves onto a bottom plate (not shown) arranged at its bottom side. The receiving nest 20 has the shape of a through-opening within said displacer 52, which is closed by the bottom plate. Additionally, the receiving nest 20 has a size to receive only one connecting element 10 therein.

During the sensing process, the displacer 52 with the receiving nest 20 is situated in a feeding position 58 (see FIG. 2). In the feeding position 58 of the displacer 52, the receiving nest 20 also adjoins a feeding device (not shown) for connecting elements 10 which supplies the connecting elements 10 to the receiving nest 20 before starting the sensing process. According to a preferred embodiment, the correctly positioned connecting element 10 individually falls in said receiving nest 20 due to gravity. It is also preferred to arrange the feeding position 58 of the displacer 52 in a certain distance to the sensing position in said sensing device 30.

If the evaluation of the distance sensor 32 provides an “OK” after the sensing, the displacer 52 is linearly moved along said base plate 80 and onto said bottom plate. This movement of the displacer 52 is carried out along an axis 70 from the feeding position 58 to a removing position 59 (see FIGS. 1 and 2). The axis 70 is preferably perpendicular to axis 60, and the moving of the displacer 52 is realized by means of a linear actuator 54, 56, as for example described with respect to the sensing device 30.

In said removing position 59, the base plate 80 releases the connecting element 10 so that it is individually removed or sorted out by means of gravity or further devices, and that it is transferred to a further processing unit (not shown).

If the displacer 52 is situated in the feeding position 58, and the evaluation provides the result “not OK” after sensing, the defective connecting element 10 has to be removed from the receiving nest 20. A preferred embodiment of the present invention provides an ejecting device 30, 40. In the base plate's portion closing the receiving nest 20 in said feeding position 58 of the displacer 52, a movable stop 42 is provided. In its closing position, said movable stop 42 provides a stopping portion for said connecting element 10 during the sensing process. Additionally, said stop 42 closes an opening 44 in said base plate 80. If the stop 42 unblocks the opening 44 in said base plate 80 in its opening position, the receiving nest 20 is opened at the side of the base plate 80 (see FIG. 2).

Said stop 42 is preferably moved along said axis 60 by means of a linear actuator 46, 48. This actuator 46, 48 is comparable to an actuator described with respect to the sensing device. Preferably, said stop 42 is fixed to a piston rod 48 of a hydraulic or pneumatic actuating cylinder 46 wherein said actuating cylinder 46 can be also realized by another actuator. According to FIG. 1, the actuating cylinder 46 with stop 42 moves along the same axis 60 also defining the moving direction of the sensing element 32. The sensing element 32 and the actuating cylinder 46 are arranged at opposite sides of the receiving nest 20. The actuating cylinder 46 moves said stop 42 out of and so far away from said opening 42 in said base plate 80 that said sensing element 32 can be displaced from the sensing position and through said receiving nest 20 to a first ejecting position to move or eject the defective connecting element 10 out of the receiving nest 20. Due to gravity, the ejected defective connecting element 10 preferably falls into a collecting box (not shown). After ejecting the defective connecting element 10, the sensing element 32 is returned to its initial position and said opening 44 is closed by the stop 42. After returning the sensing element 32 in its initial position, the receiving nest 20 is again available for receiving a new connecting element 10.

Preferably, said stop 42 and said sensing element 32 are moved back in an abutting relation until said stop 42 closes said opening 44. Thereafter, said sensing element 32 disengages said stop 42 and releases the receiving nest 20 by further moving in the direction to its initial position. The common backward movement of stop 42 and sensing element 32 prevents an incorrect positioning of a new connecting element 10 within said receiving nest 20 and, thus, also an interruption of the operation of said measuring and sorting apparatus.

Based on the above described preferred constructive elements of the inventive measuring and sorting apparatus for connecting elements, the function of said apparatus is explained in the following.

Via a feeding device, for example a feeding tube, a guiding device or a magazine, connecting elements 10 are supplied to the receiving nest 20 wherein said connecting elements 10 already have the right orientation and they are arranged in a side-by-side relation. The receiving nest 20 is specifically configured according to the connecting elements having a complementary shape to the connecting element to be received. After receiving the connecting element 10 in the receiving nest 20, the longitudinal axis of the connecting element 10 is oriented along axis 60. During the sensing process of the connecting element 10 within the receiving nest 20, i.e. during the length measurement of the connecting element 10 by means of the sensing device 30, the actuating cylinder 46 retains the stop 42 within the opening 44 of the base plate 80 to provide a stopper for the connecting element 10. Now, the sensing element 32 moves from its initial position to the sensing position for the length measurement of the connecting element 10 wherein the sensing element 32 pushes said connecting element 10 against the stop 42. After the sensing position of the sensing element 32 has been reached, the length of the connecting element 10 is determined with high accuracy by means of an analogous or digital displacement sensor. The sensing device 30 or an evaluation unit (not shown) then provides as a result of the length or displacement measurement whether the connecting element 10 is “OK” or “not OK”. Thereafter, the sorting process according to the preferred embodiment of the present invention is carried out dependent on the result of the length measurement of the connecting element 10.

If a correct connecting element 10 is contained in the receiving nest 20, the displacer 52 is moved along axis 70 from its feeding position 58 to its removing position 59 by means of the linear actuator 54, 56 whereby the correct connecting elements are separated from each other, i.e. they are moved spacially and temporally separated from each other. In the removing position 59, the receiving nest 20, configured as a through-opening through the displacer 52, is no longer aligned with the bottom plate downwardly restricting said displacer 52 so that the correct connecting element 10 falls out of the receiving nest 20 or it may be removed by an appropriate device. In this manner, the correct connecting element 10 is individually transferred to a further processing unit as for example a punch riveting machine.

If the sensing device 30 or the evaluation unit provides the result “not OK” for the respective connecting element 10, the stop 42 is moved by means of the linear actuator 46, 48. Thereby, the opening 44 in the base plate 80 is unblocked. The sensing element 32 is displaced from its sensing position through said receiving nest 20 to an ejecting position in order to push the defective connecting element 10 out of the receiving nest 20 respectively to eject said defective connecting element 10. In this way, the defective connecting elements 10 are sorted out.

After finishing the sorting process, the sensing element 32 is moved back together with the actuating cylinder 46. Before reaching its initial position, the sensing element 32 is moved in abutting relation with said stop 42 until said stop 42 has closed the opening 44 in the base plate 80. By this movement, the sensing element 32 blocks the receiving nest 20 until it is closed by the stop 42 and thereafter again available for a further measurement. Based on the backward motion of the sensing element 32 to its initial position, the receiving nest 20 is again unoccupied in order to receive a new connecting element 10 to be measured in said receiving nest 20.

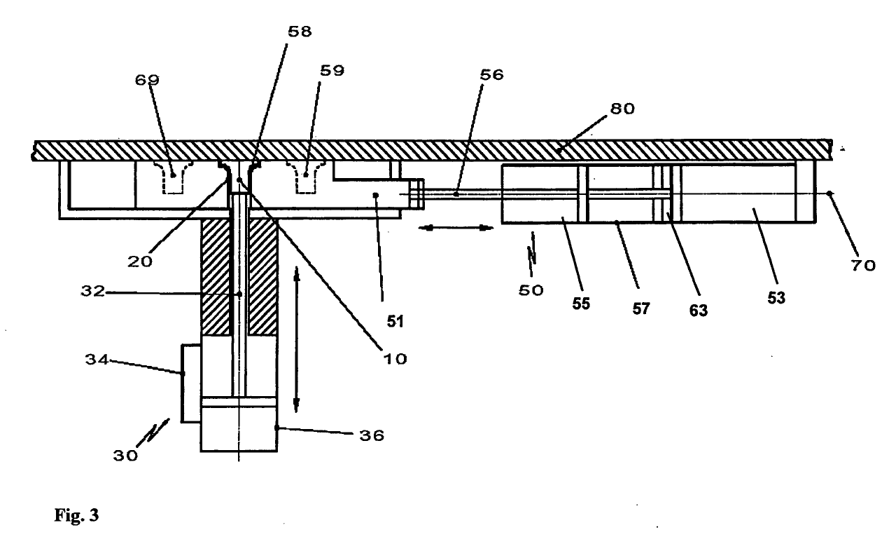

According to the embodiment shown in FIG. 3, a displacer 51 is used in the measuring and sorting apparatus which is movable between an ejecting position 69 for ejecting defective connecting elements 10, a feeding position 58 and a transferring position 59. The movement is carried out along the base plate 80 by a linear actuator 55 which can be operated hydraulically, pneumatically, electromagnetically or in any other appropriate manner. The base plate 80 forms the stop for the connecting elements 10 within the receiving nest 20 without using an opening cylinder 46.

According to the embodiment shown in FIG. 3, the displacer 51 is moved by a multi-position-cylinder 57 which is made of a double-action cylinder 55 and a single-action cylinder 53.

Both cylinders 53, 55 have piston rods separated from each other. The piston rod of the first cylinder 55 is connected to the displacer 51 for moving among the three positions 58, 59 and 69. The transferring position 59 and the ejecting position 69 are defined by the final positions of the cylinder 57. The piston rod of the second cylinder 53 forms a stop point for the piston rod of the first cylinder 55 in its extended condition so that the first cylinder 55 can move the displacer 51 in the sensing position 58. This stop point is defined by means of a stopper 63 limiting the movement of the second cylinder 53.

In said ejecting position 69 and in said transferring position 59, the connecting elements 10 are preferably removed out of the receiving nest 20 by means of gravity in such a way, that the bottom plate of the displacer 51 downwardly opens the receiving nest 20 in these positions. An automatic ejecting is also preferred. In said ejecting position 69, defective connecting elements 10 are ejected, and in said transferring position 59, correct connecting elements 10 are separated and transferred to further processing. The determination of the dimension/dimensions of the connecting element 10 is carried out in the same manner as described with respect to the embodiment according to FIG. 1.

The embodiment according to FIG. 3 functions as follows wherein it is referred to the description of the above embodiment for similar components. In this embodiment, the connecting element 10 to be measured is supplied in the same way as described above. To this end, the displacer 51 is moved to the feeding position 58 which is at the same time also the sensing position. For reaching the feeding position 58, the second actuating cylinder 53 is extended up to a maximum until it abuts the stopper 63. Additionally, pressure is applied to the chamber of the first actuating cylinder 55 which is directed to the displacer 51 so that the piston rod of the first actuating cylinder 55 is pressed against the stop point defined by the piston rod of the second actuating cylinder 53.

To move the displacer 51 from the sensing position 58 to the ejecting position 69 since a defective connecting element 10 was identified, pressure is applied to the chamber of the first actuating cylinder 55 which is opposite to the displacer 51. The displacer 51 moves to the left until reaching the ejecting position 69.

The motion from the ejecting position 69 to the sensing position 58 is realized by applying pressure to the chamber of the first actuating cylinder 55 which is directed to the displacer 51 and to the second actuating cylinder 53. The motion from the sensing position 58 to the transferring position 59 is achieved by applying pressure to the chamber of the first actuating cylinder 55 directed to the displacer 51 while the second actuating cylinder 53 remains depressurized. In this case, the second actuating cylinder 53 does no longer form a stop point in said multi-position-cylinder so that the first actuating cylinder 55 is displaced together with the displacer 51 to the right to its corresponding final position. To return the displacer 51 from the transferring position 59 to the sensing position 58, the second actuating cylinder 53 is pressurized. The piston rod of the second actuating cylinder 53 is moved until it abuts the stopper 63. Since the of the first actuating cylinder 55 is moved together with the second actuating cylinder 53 until reaching the stopper 63, the displacer 51 reaches its central position in this way, i.e. the sensing position.

The high accuracy follows from the preferred constructive details and the functioning of the inventive measuring and sorting apparatus for connecting elements to determine the dimension of a connecting element. Furthermore, the described apparatus realizes sorting and separating of defective and correct connecting elements before further processing, e.g. the punch riveting process. The system is permanently available since the separating, riveting or any further process is not interrupted due to the identification of a defective connecting element 10.

List of Reference Numerals

| | |
|---|---|
| 10 | connecting element |
| 20 | receiving nest |
| 30 | sensing device |
| 32 | sensing element |
| 34 | displacement sensor |
| 36, 32; 46, 48; | actuating cylinder |
| 54, 56; 53; 55 | |
| 40 | ejecting device |
| 42 | stop |
| 44 | opening in the base plate 80 |
| 50 | transferring device |
| 51; 52 | displacer |
| 57 | multi-position-cylinder |
| 58 | feeding position |
| 59 | transferring position |
| 60, 70 | axes |
| 63 | stopper |
| 69 | ejecting position |
| 80 | base plate |

We claim:

1. Measuring and sorting apparatus for connecting elements comprising
a. a receiving nest to which the connecting elements are supplied and in which only one connecting element is positionable in an oriented manner;
b. a sensing device sensing one or several dimensions of the connecting element positioned in said receiving nest to distinguish between defective and correct connecting elements;
c. an ejecting device ejecting defective connecting elements from the receiving nest; and
d. a transferring device transferring correct connecting elements to a further processing unit.

2. Measuring and sorting apparatus according to claim 1 in which the sensing device comprises:
a sensing element movable between an initial position outside of the receiving nest and a sensing position within the receiving nest, and
a distance sensor determining the distance between the initial position and the sensing position moved by the sensing element to determine the dimension of the connecting element.

3. Measuring and sorting apparatus according to claim 2, in which the distance sensor is a displacement transducer.

4. Measuring and sorting apparatus according to claim 2, in which the receiving nest is limited on one side by a stop against which the connecting element is pushed by the sensing element in its sensing position.

5. Measuring and sorting apparatus according to claim 4, in which the sensing element is displaceable by means of a linear actuator.

6. Measuring and sorting apparatus according to claim 5, in which the transferring device comprises a displacer in which the receiving nest is formed.

7. Measuring and sorting apparatus according to claim 6, in which the receiving nest is displaceable by means of the displacer between a feeding position adjacent a feeding unit for said connecting elements and a transferring position adjacent a transferring unit leading to a further processing unit for individualizing the connecting elements.

8. Measuring and sorting apparatus according to claim 7, in which the connecting elements are supplyable to the receiving nest in one row by means of the feeding unit wherein said connecting elements are arranged in the right position and adjacent to each other.

9. Measuring and sorting apparatus according to claim 7, in which the feeding position of the receiving nest serves as a working position in which the connecting element arranged in said receiving nest is sensed.

10. Measuring and sorting apparatus according to claim 7, in which the connecting elements are removable by gravity from the feeding device to the receiving nest as well as from the receiving nest to the transferring unit.

11. Measuring and sorting apparatus according to claim 8, in which the receiving nest is a through-opening formed in said displacer which is limited on one side by a plate.

12. Measuring and sorting apparatus according to claim 7, in which the displacer is moveable by a linear actuator.

13. Measuring and sorting apparatus according to claim 12, in which the actuator of the displacer is arranged along an axis running perpendicular to an axis of the actuator of the sensing element.

14. Measuring and sorting apparatus according to claim 4, in which the stop is movable between the closing position closing an ejecting opening and an opening position unblocking the ejecting opening.

15. Measuring and sorting apparatus according to claim 14, in which the sensing element is movable through said receiving nest to an ejecting position so that the sensing element simultaneously serves as an ejector of the ejection device.

16. Measuring and sorting apparatus according to claim 14, in which the stop is moveable by a linear actuator.

17. Measuring and sorting apparatus according to claim 16, in which the actuators of the sensing element and the stop are moved along a common axis and they are arranged on opposite sides of the receiving nest.

18. Measuring and sorting apparatus according to claim 7, in which the stop is arranged at a fixed position and in which the displacer is movable to an ejecting position for ejecting the connecting element which is separated from said feeding position and said transferring position.

19. Measuring and sorting apparatus according to claim 18, in which the actuator of the displacer is configured as multi-position-cylinder.

20. Measuring and sorting apparatus according to claim 1, in which the sensing device, the ejecting device and the transferring device are arranged at a vertical extending base plate and within a horizontal plane.
